(19) United States
(12) Patent Application Publication
(10) Pub. No.: US 2025/0319952 A1
(43) Pub. Date: Oct. 16, 2025

(54) GONDOLA FOR HIGH-SPEED MULTIBEAM ECHOSOUNDER SURVEYING BY SEMI-DISPLACEMENT OR PLANING HULL VESSELS

(71) Applicant: FNV IP B.V., Leidschendam (NL)

(72) Inventors: Chad Allen PASTOR, Crowley, LA (US); Jacob Joseph Irwin, Lafayette, LA (US); Rik Wemmenhove, Leidschndam (NL)

(21) Appl. No.: 18/634,232

(22) Filed: Apr. 12, 2024

(51) Int. Cl. B63B 49/00; B63B 1/24; G01S 7/521

(52) U.S. Cl. CPC B63B 49/00; B63B 1/242; G01S 7/521

(57) ABSTRACT

Unlocking insights from Geo-Data, the present invention relates to improvements in sustainability and environmental developments: together we create a safe and livable world. Described are systems and techniques for high-speed multibeam echosounder (MBES) surveying using a gondola attached to a semi-displacement or planing hull vessel. A housing encloses a multi-head MBES transducer array, with a nose fairing extending from a maximum width of the housing and a tail fairing extending from a minimum width of the housing. A hydrofoil strut segment has first and second hydrofoil surfaces orthogonal to the housing, and includes at a first distal end a coupling for flush attachment to an upper surface of the housing and at a second distal end a coupler portion for attachment to the semi-displacement or planing hull vessel. The first and second hydrofoil surfaces can generate opposing hydrodynamic forces during high-speed MBES surveying by the semi-displacement or planing hull vessel.

### FIELD

The present disclosure generally relates to an underwater sensing and acquisition system and methods of use thereof. For example, aspects of the present disclosure relate to a gondola apparatus for high-speed multibeam echosounder (MBES) surveying by a semi-displacement or planing hull survey vessel. Unlocking insights from Geo-Data, the present invention further relates to improvements in sustainability and environmental developments: together we create a safe and livable world.

### BACKGROUND

Marine surveying and/or other geophysical surveying performed in a marine or underwater environment can involve the collection of bathymetry data. Bathymetry data can be used for the measurement and study of the seafloor (or the floors of other bodies of water in which the bathymetry data is collected). For example, bathymetry data can be used to map depth contours of the seafloor, similar to the elevation contours mapped by topography data collected for land-based environments. Bathymetry data can be obtained using acoustic-based sensors, sensor arrays, sensor systems, etc.

For example, bathymetric data may be obtained using a multibeam echosounder (MBES), which may be mounted below a survey vessel and/or towed behind a survey vessel. Towed solutions can also comprise Side Scan Sonar (SSS) sensors. An MBES is a type of active sonar system, and may also be referred to as MBES sonar. MBES sonar can be used to map the seafloor, and/or can be used to detect objects within the water column (e.g., above the seafloor). In some examples, MBES sonar can be used to map or detect objects located on or along the seafloor. An MBES sonar can be configured to emit multiple sound beams (e.g., acoustic waves, sonar pings, etc.) in a fan-shaped pattern beneath the hull of the survey vessel associated with the MBES sonar. The multiple beams or pings emitted by an MBES sonar can be generated using a plurality of acoustic or sonar transducer elements included in the MBES sonar, with the configuration and arrangement of the transducer elements corresponding to the particular fan-shaped or other beam pattern of the MBES sonar. The multiple beams or pings interrogate the seafloor along a perpendicular line beneath the MBES sonar and the associated survey vessel, reflecting back along a return path from the seafloor to one or more receivers of the MBES.

As noted above, the MBES sonar may be hull-mounted and located within the water column directly below the survey vessel, and/or may be towed (e.g., using a towfish with e.g., a Side Scan Sonar sensor) from or behind the survey vessel using a tether. In some examples, an MBES sonar can be used to obtain bathymetric data for creating nautical maps (e.g., navigational aids or information) indicative of the minimum water depth or keel clearance at different locations within a surveyed area. The bathymetric data used for mapping the shallowest depth, keel clearance information is obtained using relatively low survey depths (e.g., 10-40 meters), for example using an MBES or other sonar sensor(s) provided within a gondola structure that is mounted beneath the lowest point of the keel of the survey vessel. Based on the relatively low survey depths, it can be difficult or impossible to use relatively large survey vessels, and smaller survey vessels are typically used to perform the shallowest depth surveying for mapping keel clearance information. These smaller survey vessels may be associated with relatively slow surveying speeds (e.g., the speed of the survey vessel and/or MBES sonars through the water during the active performance of the surveying operations). For example, MBES sonar surveying operations in shallow water are typically limited to surveying speeds of approximately 7 knots. This is, in part, due to hydrodynamic limitations of the vessel and gondola used for placement of the MBES sonar within the water column, which affects the hydrodynamic stability and the structural integrity of the gondola and its sensors (and may further be based on the inability to use larger and/or faster vessels to perform the MBES sonar survey in shallow waters). A gondola is an apparatus or structure designed for attachment to a marine vessel's hull or for positioning over the side of such a vessel. This gondola comprises a housing or enclosure capable of serving multiple functional purposes. Firstly, it may act as a stabilizing element for the vessel, contributing to the maintenance or improvement of the vessel's equilibrium and navigational efficiency in aquatic environments. Secondly, the gondola is engineered to accommodate and protect various types of sensors or surveying equipment. In addition, higher survey speeds may disrupt data acquisition due to, e.g., increases in turbulence and vibrations of the sensors. There is thus a need for an improved gondola which addresses at least one of the abovementioned problems.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some examples, systems and techniques are described for high-speed MBES surveying using a gondola attached to a semi-displacement or planing hull survey vessel. A gondola for high-speed MBES surveying by a semi-displacement or planing hull survey vessel can comprise: a housing having an enclosed volume extending between an upper surface of the housing and a lower surface of the housing, wherein a multi-head MBES transducer array is provided within the enclosed volume and extends through one or more apertures of the lower surface; a nose fairing extending from a forward portion of the housing at a maximal width of the upper surface and the lower surface; a tail fairing extending from an aft portion of the housing at a minimal width of the upper surface and the lower surface; and a hydrofoil strut segment having first and second hydrofoil surfaces extending between a first distal end of the hydrofoil strut segment and a second distal end of the hydrofoil strut segment, wherein: the first distal end of the hydrofoil strut segment includes a coupling configured for flush attachment to the upper surface of the housing; the second distal end of the hydrofoil strut segment includes a coupler portion configured for attachment to the semi-displacement or planing hull survey vessel; and the first and second hydrofoil surfaces are orthogonal to the upper surface of the housing and are configured to generate opposing hydrodynamic forces during high-speed MBES surveying by the semi-displacement or planing hull survey vessel.

In some aspects, a long-track length of the hydrofoil strut segment is the same as a length of a planar portion of the upper surface of the housing between the nose fairing and the tail fairing.

In some aspects, a long-track length of the hydrofoil strut segment is equal to at least 75% of a longitudinal length of the upper surface of the housing.

In some aspects, the gondola is configured for high-speed MBES surveying operations at speeds greater than 10 knots.

In some aspects, the gondola is configured for high-speed MBES surveying operations at speeds greater than 15 knots.

In some aspects, the gondola has a hydrodynamic profile configured to provide reduced hydrodynamic resistance at survey speeds greater than 10 knots, based at least in part on the hydrofoil strut segment comprising a rounded leading surface and a tapered trailing edge.

In some aspects, the hydrofoil strut segment further includes a pipe segment orthogonal to the upper surface of the housing and disposed between the first and second hydrofoil surfaces.

In some aspects, the first and second hydrofoil surfaces are coupled to one another along a leading edge of the hydrofoil strut segment adjacent to the nose fairing of the housing.

In some aspects, the first and second hydrofoil surfaces are coupled to one another along a trailing edge of the hydrofoil strut segment adjacent to the tail fairing of the housing, and wherein a first width of the hydrofoil strut segment at the leading edge is greater than a second width of the hydrofoil strut segment at the trailing edge.

In some aspects, wherein the hydrofoil strut segment has a third width between the leading edge and the trailing edge, and wherein the third width is greater than the first width and the second width.

In some aspects, the coupling is coplanar with the upper surface of the housing in the flush attachment of the hydrofoil strut segment first distal end to the gondola housing.

In some aspects, the multi-head MBES transducer array includes a transmitter aligned along the longitudinal axis of the housing, and first and second receivers disposed on opposite sides of the transmitter.

In some aspects, the transmitter extends through a first aperture of the one or more apertures and is substantially flush with the lower surface of the housing.

In some aspects, the first and second receivers extend through respective apertures of the one or more apertures and are each substantially flush with the lower surface of the housing.

In some aspects, the nose fairing and the tail fairing are flush with upper surface of the housing and the lower surface of the housing.

In some aspects, the upper surface of the housing comprises a triangular shape tapering from the maximal width at an attachment point with the nose fairing to the minimal width at an attachment point with the tail fairing.

In some aspects the tail fairing tapers to a point, and wherein the taper of the tail fairing is continuous along the longitudinal axis with the taper of the housing.

In some aspects, the upper surface of the housing comprises a planar surface, and wherein the lower surface of the housing comprises a curved surface.

In some aspects, a longitudinal axis of the housing extends between the nose fairing coupled to the forward portion and the tail fairing coupled to the aft portion, and the upper surface and the lower surface are tapered along the longitudinal axis of the housing from the maximal width to the minimal width.

In another illustrative example, a high-speed multibeam echosounder (MBES) surveying system is provided, the system comprising: a high-speed survey vessel having a semi-displacement hull or a planing hull; and a high-speed MBES gondola coupled to the semi-displacement hull or the planing hull of the high-speed survey vessel, wherein the high-speed MBES gondola comprises: a housing having an enclosed volume extending between an upper surface of the housing and a lower surface of the housing, wherein a multi-head MBES transducer array is provided within the enclosed volume and extends through one or more apertures of the lower surface; a nose fairing extending from a forward portion of the housing at a maximal width of the upper surface and the lower surface; a tail fairing extending from an aft portion of the housing at a minimal width of the upper surface and the lower surface; and a hydrofoil strut segment having first and second hydrofoil surfaces extending between a first distal end of the hydrofoil strut segment and a second distal end of the hydrofoil strut segment, wherein: the first distal end of the hydrofoil strut segment includes a coupling configured for flush attachment to the upper surface of the housing; the second distal end of the hydrofoil strut segment includes a coupler portion configured for attachment to the semi-displacement hull or the planing hull of the high-speed survey vessel; and the first and second hydrofoil surfaces are orthogonal to the upper surface of the housing and are configured to generate opposing hydrodynamic forces during high-speed MBES surveying by the semi-displacement hull or planing hull high-speed survey vessel.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIGS. 1A-1D are diagrams illustrating various views of an example gondola for high-speed multibeam echosounder (MBES) surveying by a survey vessel, in accordance with some examples;

FIGS. 2A-2B are diagrams illustrating perspective views of an example gondola for high-speed MBES surveying by a survey vessel, in accordance with some examples;

FIG. 3A is a diagram illustrating a front perspective view of an example gondola for high-speed MBES surveying by a survey vessel, in accordance with some examples;

FIG. 3B is a diagram illustrating a top-down view of an example gondola for high-speed MBES surveying by a survey vessel, in accordance with some examples;

FIG. 4 is a diagram illustrating a perspective view of an example gondola for high-speed MBES surveying, where the gondola is coupled to a hull of a survey vessel, in accordance with some examples;

FIG. 5 is a diagram illustrating an additional perspective view of the high-speed MBES gondola coupled to the hull of the survey vessel of FIG. 4, in accordance with some examples;

FIGS. 6A-6B illustrate perspective views of a vessel with a pole-mounted sensor acquisition apparatus mounted thereto in a stowed position and a deployed position, respectively, in accordance with some examples;

FIG. 7A is a diagram illustrating an example configuration of a high-speed MBES gondola coupled to a pole-mount sensor acquisition apparatus for deployment over the side of a survey vessel, in accordance with some examples;

FIG. 7B is a diagram illustrating an additional perspective view of the example configuration of the pole-mounted high-speed MBES gondola of FIG. 7A, in accordance with some examples; and

FIG. 8 is a block diagram illustrating an example of a computing system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

It will be appreciated that for simplicity and clarity of illustration, where appropriate, reference numerals have been repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

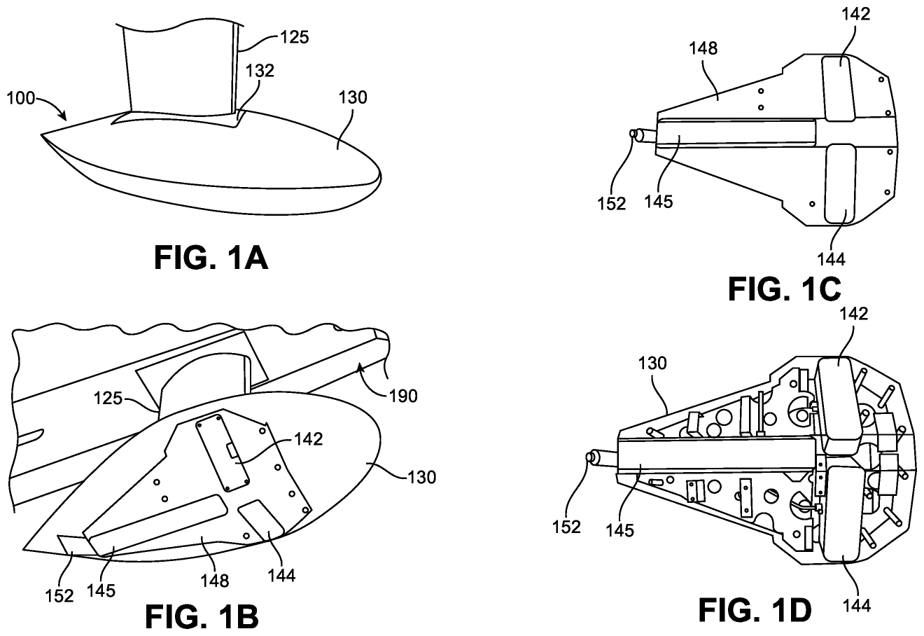

Systems and techniques are described herein for high-speed MBES surveying, for example using the disclosed high-speed MBES gondola apparatus attached to a semi-displacement or planing hull survey vessel (e.g., as will be described in greater detail below). A gondola can be provided as a construction mount and housing for an MBES sonar or MBES transducer array, where the gondola may be mounted or coupled underneath or otherwise vertically below a surveying vessel. In some aspects, the high-speed MBES gondola apparatus can have a hydrodynamic profile that is optimized for high-speed operations (e.g., surveying speeds greater than 10 knots, surveying speeds greater than 13 knots, etc.) while maintaining the structural integrity and accurate sonar performance of the MBES sonar provided within the high-speed gondola. Further details and various examples of a gondola apparatus configured for high-speed MBES surveying operations are described below with respect to the examples of FIGS. 1A-3B.

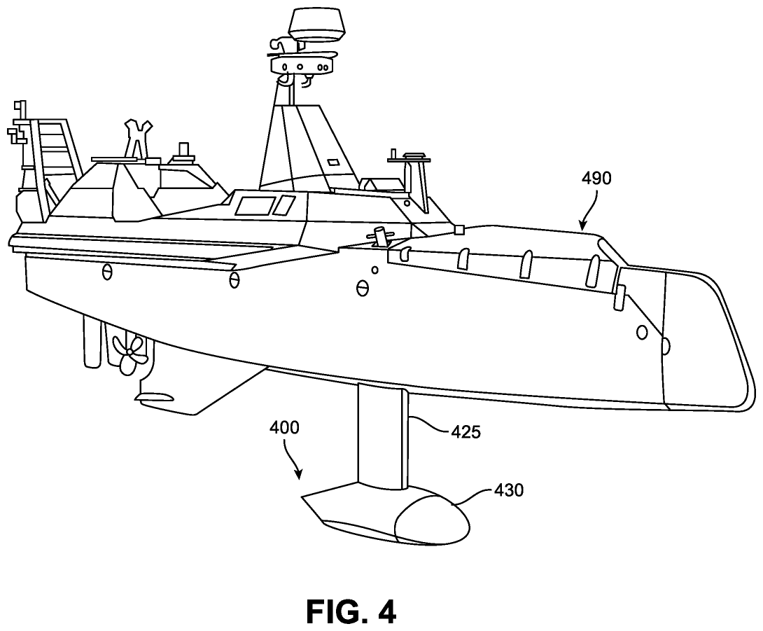

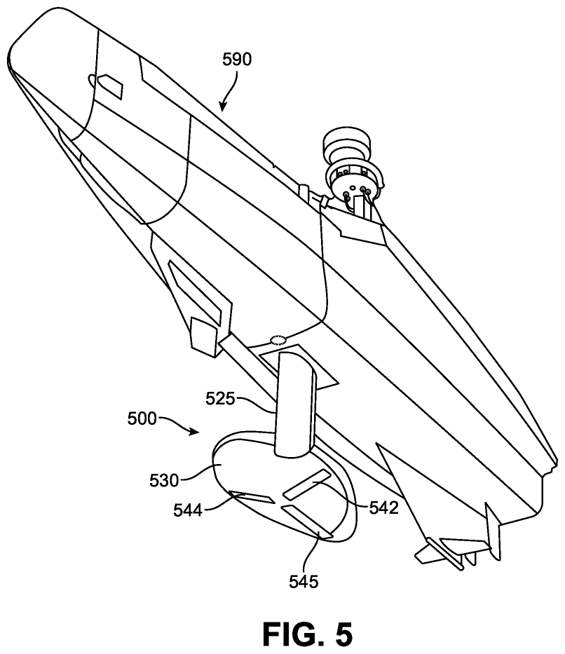

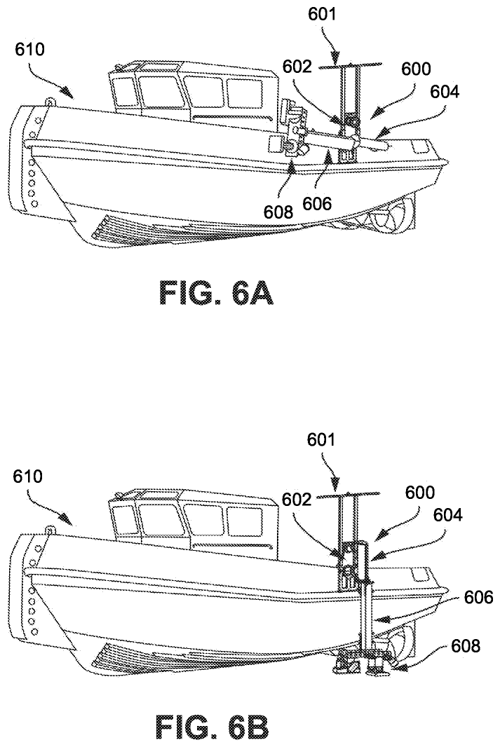

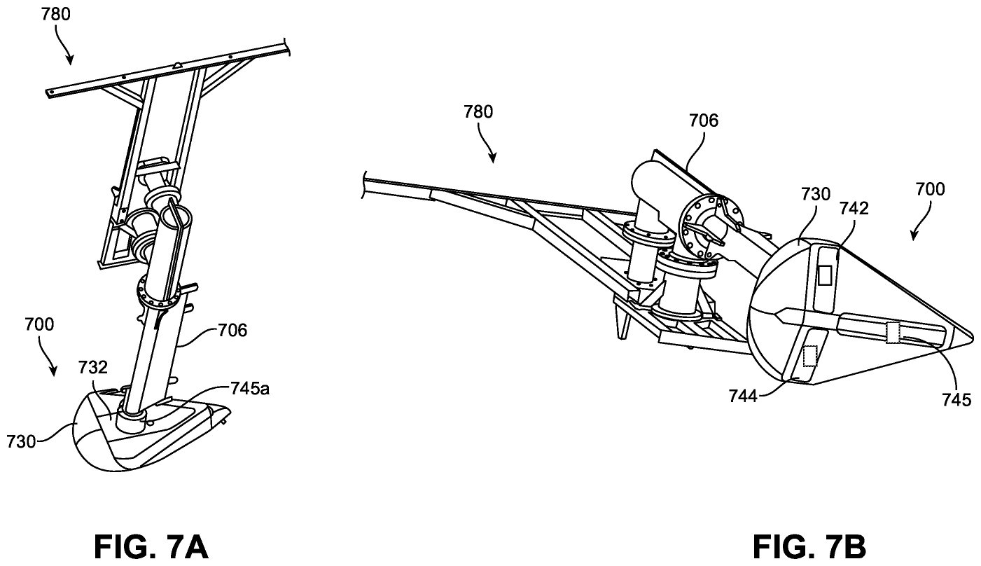

In some embodiments, the high-speed MBES gondola can be coupled directly to the hull of the surveying vessel, for example along the longitudinal centerline of the hull, underneath the surveying vessel such that the gondola (and MBES provided therewithin) is placed within the relatively undistributed water column beneath the surveying vessel. For instance, various examples of a hull-mounted configuration of the presently disclosed high-speed MBES gondola are illustrated in the examples of FIG. 4 and FIG. 5. In some embodiments, the high-speed MBES gondola can be coupled to a pole-mount sensor acquisition apparatus configured for deployment over the side of the surveying vessel. Various examples of an over the side, pole-mounted configuration of the presently disclosed high-speed MBES gondola are illustrated in the examples of FIGS. 6A-7B.

In some examples, the high-speed gondola system (also referred to as a high-speed gondola apparatus) can include a sonar and a gondola configured to receive the sonar therewithin. In one illustrative example, the high-speed gondola system includes a sonar comprising an MBES, and may be referred to as a high-speed MBES gondola and can be included in a high-speed MBES gondola system or apparatus. Various other types or configurations of sonars, acoustic sensors, etc., may additionally or alternatively be used in combination with the disclosed high-speed surveying gondola, without departing from the scope of the present disclosure. For example, while reference is made to examples where the gondola includes an MBES, it is contemplated that the gondola may additionally, or alternatively, be designed to house various other types of sonars and/or acoustic sensors, without departing from the scope of the present disclosure. For example, the presently disclosed high-speed gondola can include various active acoustic sensors, sonars, and/or echosounders, which can include one or more of a single-beam or split-beam echosounder (SBES), MBES, a sidescan sonar (SSS), a synthetic aperture sonar (SAS), a scanning sonar, a volumetric scanning sonar, etc. The high-speed surveying gondola can include a single-beam/single-frequency sonar system, or can include a multi-beam/multi-frequency sonar system.

The high-speed sonar surveying gondola system can be configured for attachment to (e.g., deployment from, during MBES or other sonar surveying operations) a survey vessel having a semi-displacement or planing hull design that can support the relatively high-speed surveying operations. For example, in some embodiments, the presently disclosed high-speed gondola can be coupled to and deployed from a “fast trawler” type vessel (also referred to as a high-speed trawler) with a semi-displacement or planing hull optimized for operations at speeds of 10 knots or greater (e.g., 11-19 knots, etc.). In some examples, the high-speed gondola can be coupled to and deployed from a survey vessel with a semi-displacement or planing hull optimized for operations at speeds of 14 knots or greater.

A semi-displacement hull, also referred to as a “semi-planing hull”, is a type of boat or vessel hull design that combines characteristics of displacement hulls (e.g., where the vessel's weight is supported by the buoyant force of the water displaced by the vessel) and characteristics of planing hulls (e.g., where a significant portion of the vessel's weight is lifted out of the water as the vessel gains speed, thereby allowing the vessel to “plane” on top of the water surface). A semi-displacement hull can be implemented as a hybrid design of displacement and planing hulls, and semi-displacement hull vessels can be operated efficiently over a wider range of speeds, with better performance and/or fuel efficiency compared to conventional displacement hulls, planing hulls, or both. A planing hull is a hull configuration where a significant portion of the vessel's weight is supported by hydrodynamic lift rather than buoyancy alone as the vessel accelerates. This allows the vessel to rise out of the water, reducing contact surface area with the water and, consequently, drag. As the vessel gains speed, it “planes” on top of the water surface, enabling higher speeds and more efficient travel. This phenomenon occurs because the dynamic force from the water beneath the hull lifts a substantial part of the vessel, allowing it to glide at the water's surface.

In a displacement-based vessel hull design, the vessel's weight may be entirely supported by the buoyant force of the water that is displaced by the vessel's hull. Displacement hulls can be designed to move through the water with relatively low (or minimal) resistance. However, the maximum speed of a displacement hull vessel may be associated with practical limits relating to the waterline length of the hull, in what is known as the hull speed or displacement speed. For example, the hull speed (e.g., displacement speed) refers to the speed at which the wavelength of a vessel's bow wave is equal to the waterline length of the vessel, where the bow and stern waves of the vessel begin interfering constructively to create large amounts of drag. Accordingly, as the speed of a displacement hull vessel increases, the resistance or drag forces acting upon the vessel may increase rapidly, making it impractical and inefficient for the vessel to travel beyond a certain speed.

In a planing-based vessel hull design, a portion of the vessel's weight is supported by lift forces generated by hydrofoils or other lifting surfaces of the planing hull vessel. For example, a planing hull can be designed to lift a significant portion of the vessel's weight out of the water as the vessel gains speed. Accordingly, the wetted surface area of a planing hull vessel can be reduced, and allows the vessel to plane on top of or above the surface of the water, thereby achieving higher speeds than a pure displacement hull. While planing hull vessel designs may be slightly less efficient at lower speeds (e.g., where the vessel is not lifted out of the water and acts as a pure displacement hull, etc.), it may still be a very beneficial hull type for high-speed surveys.

In combining characteristics of displacement hulls and planing hulls, a semi-displacement hull (e.g., a semi-planing hull) may behave similar to a displacement hull when traveling at lower speeds, thereby providing stability and fuel efficiency. At higher speeds, the semi-displacement or planing hull may gradually lift out of the water, reducing the wetted surface area and allowing the vessel to achieve higher speeds more efficiently than a pure displacement hull. A semi-displacement hull may be designed such that the vessel does not fully plane above the surface of the water (e.g., as a pure planing hull vessel would, given sufficient speed).

In some examples, the shape or geometric profile of a semi-displacement or planing hull vessel may be characterized by a relatively sharp bow entry, which gradually transitions into a flatter and wider section towards the stern. The bow refers to the forward portion of the hull, i.e., the front portion of the vessel that first encounters the water as the vessel moves forward. The stern refers to the aft or rear portion of the vessel, located opposite the bow along the longitudinal length of the vessel. The relatively sharp bow entry associated with semi-displacement or planing hull vessels can allow the hull to slice through the water more easily at low speeds while still providing lift as the speed increases. Semi-displacement or planing hulls may, in at least some examples, include chines for additional lift and/or stability (e.g., sharp, angular longitudinal edges or lines formed along the length of the vessel where the bottom of the hull meets the sides).

As noted previously, marine and/or geophysical surveying within a marine or underwater environment can be based on the collection of bathymetry data (also referred to as bathymetric data) relating to the measurement and study of the seafloor and/or water column extending between the seafloor and the surface. An MBES can be utilized in marine surveying operations for bathymetric data acquisition, for example to map the seafloor and water depth, to detect objects within the water column, to detect objects on or along the seafloor itself, etc. In another example, an MBES can be utilized for marine surveying operations associated with determining shallowest depth and/or keel clearance information for a surveyed area or body of water (e.g., the shallowest depth from the surface of the water to the seafloor or top of an object resting on the seafloor). An MBES is a type of active sonar system, and may also be referred to as MBES sonar. An MBES sonar can be configured to emit multiple sound beams (e.g., acoustic waves, sonar pings, etc.) in a fan-shaped pattern beneath the hull of the survey vessel associated with the MBES sonar. The multiple beams or pings emitted by an MBES sonar can be generated using a plurality of acoustic or sonar transducer elements included in the MBES sonar, with the configuration and arrangement of the transducer elements corresponding to the particular fan-shaped or other beam pattern of the MBES sonar. The multiple beams or pings interrogate the seafloor along a perpendicular line beneath the MBES sonar and the associated survey vessel, reflecting back along a return path from the seafloor to one or more receivers of the MBES.

In marine surveying operations using an MBES, the MBES may be hull-mounted and located within the water column directly below the survey vessel, and/or may be towed (e.g., using a towfish) from or behind the survey vessel using a tether. Conventional approaches to marine surveying using one or more MBES sonars are associated with relatively slow surveying speeds (e.g., the speed of the survey vessel and/or MBES sonars through the water during the active performance of the surveying operations). For example, MBES sonar surveying operations (including shallow water surveys utilizing relatively small survey vessels) are typically limited to surveying speeds of approximately 7 knots, due to characteristics of the survey vessel and/or the hydrodynamic profile and characteristics of a gondola used for placement of the MBES sonar within the water column.

The systems and techniques described herein can be used to provide a high-speed gondola for MBES surveying operations at speeds of 10 knots or greater (in some aspects, speeds of 13 knots or greater, speeds of 14 knots or greater, etc.).

FIGS. 1A-1D are diagrams illustrating various views of an example gondola for high-speed multibeam echosounder (MBES) surveying by a survey vessel, in accordance with some examples.

For example, FIG. 1A depicts a perspective view of a high-speed gondola 100 comprising a housing 130 and a hydrofoil strut segment 125 that can be used to couple or otherwise attach the high-speed gondola 100 to a survey vessel. In some embodiments, the survey vessel is a semi-displacement or planing hull survey vessel capable of sustained surveying speeds greater than 10 knots. For example, the hydrofoil strut 125 can couple the high-speed gondola 100 to the semi-displacement or planing hull of a survey vessel, and/or can couple the high-speed gondola 100 to a pole-mount sensor acquisition apparatus for over the side deployment of the high-speed gondola 100 form the survey vessel. A coupler plate 132 can be provided on or attached to an upper surface of the housing 130 of the high-speed gondola 100, and can be used to couple the gondola housing 130 to the hydrofoil strut segment 125.

FIG. 1B depicts a perspective view of the high-speed gondola 100, coupled to the hull 190 of a survey vessel (e.g., a semi-displacement or planing hull survey vessel, wherein the hull 190 is a semi-displacement or planing hull). FIG. 1C depicts a bottom view of the high-speed gondola 100, with the gondola housing 130 not shown in the example bottom view of FIG. 1C. FIG. 1D depicts another bottom view of the high-speed gondola 100, with the gondola housing 130 shown in cutaway profile only (e.g., with the enclosed inner volume of the housing 130 shown in the example view of FIG. 1D).

As depicted in FIG. 1B, the housing 130 of the high-speed gondola 100 can be coupled to the semi-displacement or planing hull 190 of the survey vessel by the hydrofoil strut 125, where a first distal end of the hydrofoil strut 125 is coupled to the vessel hull 190 and a second distal end of the hydrofoil strut 125 is coupled to the high-speed gondola (e.g., for example, coupled to the coupler plate 132 shown in FIG. 1A on the upper surface of the gondola housing 130).

As shown in FIGS. 1B-ID, the high-speed gondola 100 can include one or more acoustic transducers 142, 144, 145 configured to perform active acoustic surveys of a seafloor, water column, and/or marine environment below the hull 190 of the survey vessel. In an illustrative example, the transducers may be arranged in a Mills Cross arrangement, in which the receiver and transmitters are arranged in an orthogonal arrangement to one another. In one illustrative example, the acoustic transducers 142, 144, 145 comprise an MBES. For example, the acoustic transducer 145 can be configured as an acoustic or sonar transmitter of the MBES, and may be aligned or oriented along a longitudinal axis or centerline of the lower surface of the high-speed gondola housing 130. The acoustic transducers 142 and 144 can be configured as acoustic or sonar receivers of the MBES, and may be aligned or oriented to be substantially perpendicular to the MBES transmitter 145 (e.g., substantially perpendicular to the longitudinal axis or centerline of the lower surface of the high-speed gondola housing 130). In some aspects, a first MBES receiver 142 can extend through a corresponding aperture on a first side of the longitudinal MBES transmitter 145, and a second MBES receiver 144 can extend through a corresponding aperture on a second side of the longitudinal MBES transmitter 145 (e.g., such that the first and second MBES receivers 142, 144 are disposed on opposite sides of the longitudinal MBES transmitter 145). In some aspects, the MBES transmitter 145 and the MBES receivers 142, 144 can each extend through a corresponding aperture of lower gondola skin or gondola plate 148 on the lower surface of the high-speed gondola housing 130.

A water velocity sensor 152 can be disposed towards the aft (e.g., rear) of the high-speed gondola housing 130 and the semi-displacement or planing hull 190 of the survey vessel used to deploy the high-speed gondola 100/high-speed gondola housing 130. The placement of the water velocity sensor 152 can be designed to provide a clean (e.g., non-turbulent) water flow to and over the water velocity sensor 152, for a more accurate measurement of the water velocity.

In one illustrative example, the high-speed gondola housing 130 can define an enclosed interior volume extending between an upper surface of the housing 130 (e.g., the surface of the housing 130 located towards the hull 190 of the survey vessel) and a lower surface of the housing 130 (e.g., the surface of the housing 130 located away from the hull 190 of the survey vessel, opposite from the upper surface of the housing 130). For example, the enclosed, interior volume of the gondola housing 130 can be seen in the cutaway bottom view of the high-speed gondola apparatus 100 as depicted in the example of FIG. 1D.

In some embodiments, the upper surface of the gondola housing 130 can be a planar (e.g., flat or substantially flat) surface. The flat or substantially flat upper surface of the gondola housing 130 can be designed to reduce turbulence during surveying operations and/or to prevent undesirable turbulence at the upper surface of the gondola housing 130 during surveying operations. For example, the upper surface of the gondola housing 130 can be provided as a flat (e.g., planar) surface, based at least in part on the bolts or other couplers being sunk below the upper surface of the gondola housing 130 and/or being installed to be flush or substantially flush with the upper surface of the gondola housing 130. In some embodiments, the upper surface of the gondola housing 130 may comprise a plurality of separate or discrete plates that are attached to one another to thereby collectively form the flat (e.g., planar) upper surface of the gondola housing 130. In examples where multiple plates are used, the upper surface of the gondola housing 130 can additionally, or alternatively, be provided as a flat (e.g., planar) surface based at least in part on the upper surface being designed without any vertical steps, protrusions, or height differences between the multiple plates. In some examples, the upper surface of the gondola housing 130 can be a curved surface. The lower surface of the gondola housing 130 can be a curved surface. For instance, the lower surface of the gondola housing 130 may be curved to correspond (at least in part) to a 10 to 15-degree angular tilt or offset of the MBES receivers 142, 144 relative to the MBES transmitter 145.

The gondola housing 130 may include a nose fairing (e.g., also referred to as a nose cone, nose portion, etc.) that is located fore (e.g., forward, ahead of, etc.) of the MBES receivers 142, 144. The gondola housing 130 can additionally include a tail fairing (e.g., also referred to as a tail cone, tail portion, etc.) that is located aft of (e.g., behind) the MBES receivers 142, 144. In some embodiments, the nose fairing and/or the tail fairing may be detachably coupled to the remaining portion(s) of the high-speed gondola housing 130. In some examples, the nose fairing and/or the tail fairing may be integrally formed with the remaining portion(s) of the high-speed gondola housing 130.

The gondola housing 130 can have a tapered shape and/or width along the longitudinal axis running from fore to aft (e.g., the gondola housing 130 can taper along its longitudinal length or centerline from the nose fairing/forward portion of the housing 130 to the tail fairing/rearward portion of the housing 130), approximately corresponding to a left-right axis or direction in the example perspectives shown in the respective views of FIGS. 1A-ID.

For example, the gondola housing 130 may have a maximal width at the location of the first and second MBES receivers 142, 144, which can be aligned with one another as shown in FIGS. 1B-1D (and which can be aligned further with the MBES transducer 145 in a ‘T’-shaped configuration, as also shown in FIGS. 1B-1D). The gondola housing 130 can taper down (e.g., reduce in width) from the maximal width at the two aligned MBES receivers 142, 144 to a lesser width at the foremost tip of the nose fairing.

The gondola housing 130 can additionally taper down (e.g., reduce in width) from the maximal width at the location of the two aligned MBES receivers 142, 144 to a minimal width located at the tail fairing. In other words, the minimal width of the tail fairing or tail portion of the gondola housing 130 can be the minimal width of the gondola housing 130 as a whole, such that the width at the tip of the tail fairing (e.g., the leftmost end of the gondola housing 130 as shown in at least FIGS. 1C and 1D) is smaller than the width at the tip of the nose fairing (e.g., the rightmost end of the gondola housing 130 as shown in at least FIGS. 1C and 1D). In some examples, the gondola housing 130 can taper to a point at the tail fairing/aft end of the housing 130, for instance as shown in the example perspective views of at least FIGS. 1A and 1B.

In some aspects, the coupling or coupler plate 132 used to attach or couple the upper surface of the gondola housing 130 to the hydrofoil strut segment 125 can be configured for flush attachment. For example, the upper surface of the gondola housing 130 and the coupler plate 132 can be flush with one another (i.e., coplanar), as shown in the example of FIG. 1A. The flush and coplanar attachment of the coupler plate 132 and hydrofoil strut segment 125 to the upper surface of the high-speed gondola housing 130 can reduce turbulence at the interface between the hydrofoil strut segment 125 and the upper surface of the gondola housing 130, and may thereby enable the high-speed MBES surveying operations with the high-speed MBES gondola apparatus 100 to be performed with improved accuracy, reduced noise, or both.

In some aspects, a hydrodynamic profile associated with one or more of the high-speed gondola housing 130 and/or the hydrofoil strut segment 125 (or the combination thereof) can be optimized to reduce acoustic noise and/or turbulence at the MBES receivers 142, 144 when the survey vessel 190 and gondola apparatus 100 are used for high-speed MBES surveying at speeds greater than 10 knots. Based on the hydrodynamic profile reducing the acoustic noise and/or turbulence at the MBES receivers, including for high-speed MBES surveying at speeds greater than 10 knots, the MBES receivers 142, 144 can more accurately and efficiently measure the reflected sonar return signal associated with the pings transmitted by the MBES transmitter 145 when high-speed surveying operations are underway.

In some examples, existing and/or conventional gondola designs do not allow for increased speeds during MBES surveying operations or other MBES-based measurements. For example, conventional and existing gondolas suitable for use with an MBES sonar or MBES transducer array may be limited to a maximum surveying speed of approximately 7 knots, with operations above this speed being associated with increased turbulence, noise, recirculation, etc., that degrades the resulting MBES sonar data quality. In some cases, the limitations in conventional gondola designs can be seen to arise from their hydrodynamic profiles and structural configurations, which are not conducive to high-speed travel at survey speeds greater than 7 knots and/or at the relatively high-speed survey speeds contemplated herein for the disclosed high-speed gondola (e.g., speeds of 10 knots or greater, 11 knots or greater, 13 knots or greater, 14 knots or greater, etc.). For instance, at increased speeds, existing and conventional gondolas may encounter augmented (e.g., increased) hydrodynamic resistance and/or may experience compromised acoustic data integrity due to increased turbulence and flow distortion around the sensor array. To address these deficiencies, the disclosed systems and techniques provide the high-speed MBES gondola and associated high-speed MBES surveying operations using the high-speed MBES gondola involves the implementation a novel gondola design. For example, the disclosed high-speed MBES gondola design, which may be configured for integration with the fast trawler or other semi-displacement or planing type hull of the survey vessel, addresses the high-speed operational challenges by featuring an optimized hydrodynamic profile that minimizes resistance and flow disturbance at elevated velocities of the survey vessel. This design facilitates the effective operation of the MBES system at higher speeds without compromising data quality, thereby overcoming the limitations observed in conventional gondola designs.

As noted above, the hydrofoil strut segment 125 can be configured for flush (e.g., coplanar) attachment with the upper surface of the high-speed gondola housing 130, wherein the flush or coplanar attachment includes all three of the hydrofoil strut segment 125 distal end, the upper surface of the high-speed gondola housing 130, and the coupling or coupler plate 132 (if present). Based on the flush attachment of the hydrofoil strut segment 125 at the upper surface of the gondola housing 130, the hydrodynamic profile of the gondola apparatus 100 can be optimized to reduce noise and turbulence sensed by or otherwise detected by the MBES receivers 142, 144 (as noted above). In particular, the flush attachment of the hydrofoil strut segment 125 to the upper surface of the gondola housing 130 can be associated with preventing recirculation and/or reducing turbulent flow at an interface between the hydrofoil strut segment 125 distal end/coupler plate 132, and the upper surface of the gondola housing 130. For example, a non-flush attachment may cause significantly increased recirculation, turbulence, and noise at relatively high-speed surveying operations (e.g., greater than or equal to 10 knots, etc.), and the flush attachment can be designed to allow the high-speed MBES surveying operations with the MBES gondola apparatus 100 to be performed accurately and efficiently for survey speeds greater than 10 knots.

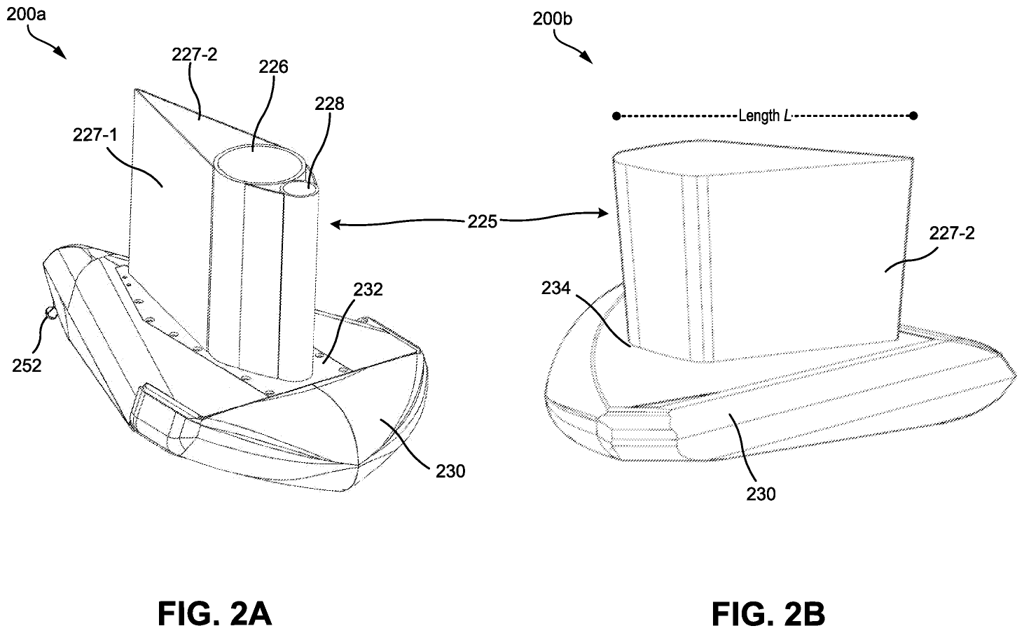

FIGS. 2A-2B are diagrams illustrating perspective views of an example high-speed gondola apparatus 200a, 200b (respectively) for high-speed MBES surveying by a survey vessel (e.g., a semi-displacement or planing hull survey vessel), in accordance with some examples. For example, FIG. 2A depicts a front perspective view of an example high-speed gondola apparatus 200a, and FIG. 2B depicts a side perspective view of an example high-speed gondola apparatus 200b (which in at least some embodiments can be the same as or similar to the high-speed gondola apparatus 200a of FIG. 2A).

In some aspects, the high-speed gondola apparatus 200a of FIG. 2A and/or the high-speed gondola apparatus 200b of FIG. 2B can be the same as or similar to the high-speed gondola apparatus 100 of FIGS. 1A-1D. For example, a high-speed gondola housing 230 of FIGS. 2A-2B can be the same as or similar to the high-speed gondola housing 130 of FIGS. 1A-1D. A coupling or coupler plate 232 of FIG. 2A can be the same as or similar to the coupling or coupler plate 132 of FIGS. 1A-1D. The water velocity sensor 252 of FIG. 2A can be the same as or similar to the water velocity sensor 152 of FIGS. 1A-1D. The hydrofoil strut segment 225 of FIGS. 2A-2B can be the same as or similar to the hydrofoil strut segment 125 of FIGS. 1A-1D.

As illustrated in FIGS. 2A and 2B, the high-speed gondola apparatus 200a and 200b (collectively referred to herein as the “high-speed gondola apparatus 200”, “high-speed gondola 200”, or “gondola 200”) can have a gondola housing 230 with a flat or substantially flat (e.g., planar or substantially planar) upper surface. For example, the planar upper surface of the gondola housing 230 can be perpendicular (e.g., orthogonal) to the hydrofoil strut segment 225 used to couple, attach, or otherwise deploy the high-speed gondola 200 from the survey vessel (e.g., a semi-displacement or planing hull vessel, as described previously above).

In some aspects, the planar upper surface of the gondola housing 230 can form a 90-degree angle at the interface 234 between the gondola housing 230 upper surface and the hydrofoil strut segment 225. For example, the interface 234 can be the same as or similar to the interface described above with respect to the flush attachment of between the hydrofoil strut and the high-speed gondola housing that can be configured to provide a hydrodynamic profile that reduces turbulence, noise, and/or recirculation at the interface 234 to thereby improve the quality of MBES survey or bathymetric data obtained at high-speed survey operations performed at speeds greater than 10 knots while using the MBES receiver heads 142, 144 of FIGS. 1B-1D (e.g., which can be the same as or similar to a dual-head MBES included in the gondola apparatus 200 of FIGS. 2A-2B, but not visible in either perspective view of FIG. 2A or FIG. 2B).

In some embodiments, the hydrofoil strut segment 225 can have first and second hydrofoil surfaces that extend between a first distal end of the hydrofoil strut segment 225 (e.g., the bottom distal end in the perspectives of FIGS. 2A-2B, at the flush attachment point/interface 234 formed with the planar upper surface of the gondola housing 230) and a second distal end of the hydrofoil strut segment 225 that is opposite from the first distal end (e.g., the second distal end being the top distal end of the hydrofoil strut segment 225 as shown in the perspectives of FIGS. 2A-2B, away from the gondola housing 230).

For example, the hydrofoil strut segment 225 can include a first hydrofoil surface 227-1 and a second hydrofoil surface 227-2 that are disposed in a wedge shape to enclose a central, first pipe segment 226 defining a maximum width of the hydrofoil strut segment 225. In some embodiments, the first and second hydrofoil surfaces 227-1, 227-2 can taper in a wedge shape from the maximal width at the first pipe segment 226 down to a minimal width towards the tail fairing/aft end of the gondola housing 230 (e.g., the left end in the perspective of FIG. 2A; the right end in the perspective of FIG. 2B). The diameter of the first pipe segment 226 can define the maximal width of the hydrofoil strut segment 225. For example, in some embodiments, the first pipe segment 226 can be a 6-inch pipe segment (e.g., having a 6-inch diameter) or other pipe segment configured to couple to a 6-inch pipe flange at the second distal end of the hydrofoil strut segment 225.

The first and second hydrofoil surfaces 227-1, 227-2 (respectively) can have an additional taper in an additional wedge or trapezoid shape extending from the maximal width at the first pipe segment 226, down to a second width towards the nose fairing/forward end of the gondola housing 230 (e.g., the right end in the perspective of FIG. 2A; the left end in the perspective of FIG. 2B). In some embodiments, a second pipe segment 228 can be enclosed within or between the first and second hydrofoil surfaces 227-1, 227-2 towards the nose fairing/forward end of the gondola housing 230. The diameter of the second pipe segment 228 can define the second width of the tapered nose portion or forward end of the hydrofoil strut 225. The diameter of the second pipe segment 228 can be the less than the diameter of the first pipe segment 226, but greater than the minimal width of the hydrofoil strut 225 at the tail fairing/tail end of the gondola housing 230.

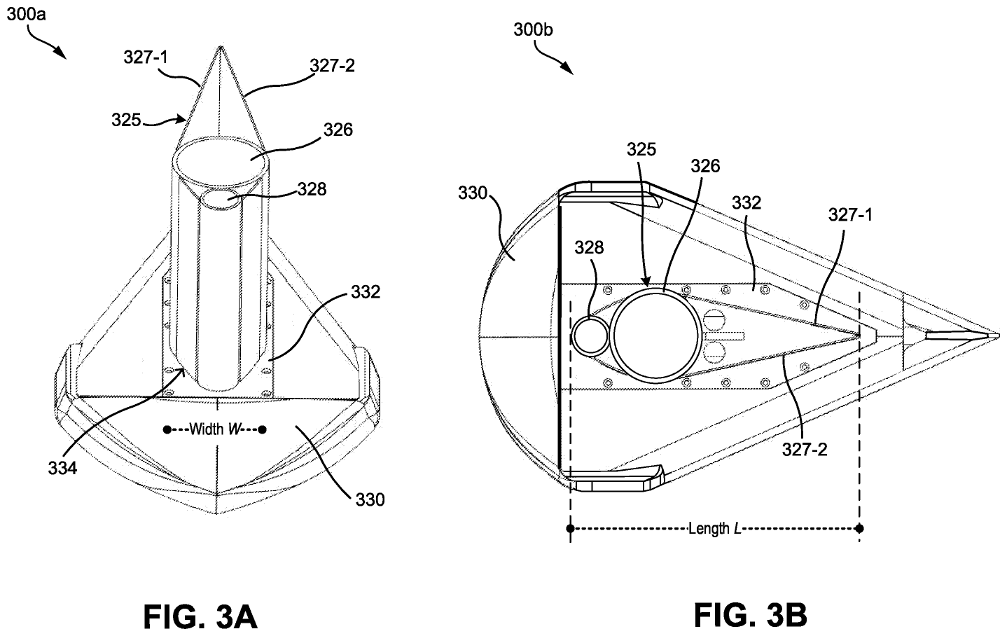

FIG. 3A is a diagram illustrating a front perspective view of an example high-speed gondola apparatus 300a for high-speed MBES surveying by a survey vessel (e.g., a semi-displacement or planing hull survey vessel), in accordance with some examples. FIG. 3B is a diagram illustrating a top-down view of an example high-speed gondola apparatus 300b for high-speed MBES surveying by a survey vessel, in accordance with some examples. In some aspects, the high-speed gondola apparatus 300a of FIG. 3A can be the same as or similar to the high-speed gondola apparatus 300b of FIG. 3B.

In some aspects, the high-speed gondola apparatus 300a of FIG. 3A and/or the high-speed gondola apparatus 300b of FIG. 3B can be the same as or similar to the high-speed gondola apparatus 100 of FIGS. 1A-1D, the high-speed gondola apparatus 200a of FIG. 2A, and/or the high-speed gondola apparatus 200b of FIG. 2B. For example, a gondola housing 330 of FIGS. 3A-3B can be the same as or similar to the gondola housing 130 of FIGS. 1A-1D and/or the gondola housing 230 of FIGS. 2A-2B. A hydrofoil strut segment 325 of FIGS. 3A-3B can be the same as or similar to the hydrofoil strut segment 125 of FIGS. 1A-1D and/or the hydrofoil strut segment 225 of FIGS. 2A-2B. The first hydrofoil surface 327-1 of FIGS. 3A-3B can be the same as or similar to the first hydrofoil surface 227-1 of FIGS. 2A-2B. The second hydrofoil surface 327-2 of FIGS. 3A-3B can be the same as or similar to the second hydrofoil surface 227-2 of FIGS. 2A-2B. The first pipe segment 326 within the hydrofoil strut segment 325 of FIGS. 3A-3B can be the same as or similar to the first pipe segment 226 within the hydrofoil strut segment 225 of FIGS. 2A-2B. The second pipe segment 328 within the hydrofoil strut segment 325 of FIGS. 3A-3B can be the same as or similar to the second pipe segment 228 within the hydrofoil strut segment 225 of FIGS. 2A-2B. The interface 334 at the upper surface of the gondola housing 330 with the hydrofoil strut segment 325 can be the same as or similar to the interface 224 of FIG. 2A. The coupling/coupler plate 332 of FIGS. 3A-3B can be the same as or similar to the coupling/coupler plate 132 of FIGS. 1A-1D and/or the coupling/coupler plate 232 of FIGS. 2A-2B. The longitudinal length L of the hydrofoil strut segment 325 and/or coupling 332 shown in FIG. 3B can be the same as or similar to the longitudinal length L of the hydrofoil strut segment 225 and/or coupling 232 shown in FIG. 2B.

In some aspects, the width W shown in FIG. 3A can correspond to the maximal width of the hydrofoil strut 325. For example, the width W (and the maximal width of the hydrofoil strut 325) may be the same as the diameter of the first pipe segment 326 that is internal to the hydrofoil strut 325 and enclosed by the first and second hydrofoil surfaces 327-1, 327-2 (respectively). The first pipe segment 326 and/or the second pipe segment 328 can be included to provide structural support or structural integrity to the hydrofoil strut 325, which is configured to attach or connect the high-speed gondola apparatus 300a/300b to the underside of a semi-displacement or planing hull survey vessel (e.g., as in the examples of FIG. 4 and FIG. 5) and/or to a pole-mount sensor acquisition system for over the side deployment of the high-speed gondola apparatus 300a/300b from deck or sidewall of the semi-displacement or planing hull vessel (e.g., as in the examples of FIGS. 6A-7B).

The first and second hydrofoil surfaces 327-1, 327-2 can be orthogonal to the upper surface of the high-speed gondola housing 330, and can define a flush attachment interface (e.g., a 90-degree interface at the attachment 334 between the hydrofoil surfaces 327-1, 327-2 and the upper surface of the gondola housing 330, along the length L). The hydrofoil surfaces 327-1 and 327-2 can be symmetric about the centerline or longitudinal axis of the gondola housing 330, for example as shown in the top-down view of FIG. 3B. The hydrofoil surfaces 327-1, 327-2 can be configured to generate opposing hydrodynamic forces during high-speed MBES surveying operations conducted by the semi-displacement or planing surveying vessel to which the high-speed MBES gondola 300a/300b is attached to or otherwise deployed from.

In some aspects, the first and second hydrofoil surfaces 327-1, 327-2 can generate respective hydrodynamic forces that reduce or minimize hydrodynamic drag in the forward direction (e.g., the direction of travel of the survey vessel), based at least in part on improved water flow field around the surfaces 327-1, 327-2 and a corresponding reduction in turbulence. In some embodiments, the size or surface area of the first hydrofoil surface 327-1 and the second hydrofoil surface 327-2 can be the same. The surface area of the hydrofoil surfaces 327-1, 327-2 can be configured to reduce the roll motion of the survey vessel to which the high-speed MBES gondola apparatus 300a/300b is attached to or deployed from. For example, the reduction in rolling motion of the survey vessel can be greater relative to a configuration with a smaller diameter vertical pipe section 326 between the gondola housing 330 and the survey vessel. A reduction in the rolling motion of the survey vessel can improve the MBES data quality collected by or obtained using the MBES within the high-speed MBES gondola apparatus 300a/300b.

In some aspects, the leading edge or leading surface of the hydrofoil strut 325 has a curvature corresponding to the cylindrical leading pipe segment 328 (e.g., second pipe segment 328) provided within the hydrofoil strut 325. For example, the leading surface of the hydrofoil strut 325 can comprise a curved surface located between the first and second hydrofoil surfaces 327-1, 327-2. As used herein, the “leading surface”, the first hydrofoil surface 327-1, and the second hydrofoil surface 327-2 may refer to different portions or areas of the outer surface or skin of the hydrofoil strut 325 (e.g., provided over and enclosing the pipe segments 326 and 328), where the different portions or areas are integrally formed with one another to provide a smooth and continuous outer surface or skin for the hydrofoil strut 325.

The tapered trailing edge of the hydrofoil strut 325 outer surface or skin can come to a point, at the aft end of the hydrofoil strut 325 (e.g., at the minimal width of the hydrofoil strut 325, towards the tail fairing of the gondola housing 330 and where the first and second hydrofoil surfaces 327-1, 327-2 meet). In some embodiments, the hydrodynamic profile of the hydrofoil strut 325 (and/or the first and second hydrofoil surfaces 327-1, 327-2) can be associated with reduced drag and vibration of the MBES gondola 300a/300b during high-speed surveying operations of 10 knots or greater, where the reduction in drag and vibration is based at least in part on the rounded leading surface of the hydrofoil strut 325 (e.g., corresponding to the curvature of the second pipe segment 328) and the tapered trailing edge.

In some embodiments, the ratio of the cross-sectional area of the hydrofoil strut 325 to the surface area of the flat, upper surface portion of the gondola housing 330 can be approximately 1:3.75. In some examples, the maximal width (e.g., the width W of FIG. 3A) of the hydrofoil strut 325 can be approximately 10-11 inches. In one illustrative example, the maximal width (e.g., the width W of FIG. 3A) of the hydrofoil strut 325 can be 10.75 inches.

In some aspects, the length L shown in FIG. 3B (and in FIG. 2B) can represent the long-track length of the hydrofoil strut 325. In one illustrative example, the long-track length L of the hydrofoil strut 325 can be 34 inches, and the ratio W:L between the maximal width and the long-track length of the hydrofoil strut 325 can be equal to approximately 1:3.18.

In some embodiments, the long-track length L of the hydrofoil strut 325 can be approximately equal to the length of a flat portion of the upper surface of the gondola housing 330. For example, the nose fairing portion of the gondola housing 330 upper surface may be curved to optimize the hydrodynamic profile thereof, and/or the tail fairing portion of the gondola housing 330 upper surface may be curved to optimize the hydrodynamic profile thereof. The upper surface of the gondola housing 330 can be flat (e.g., planar, and substantially orthogonal to the hydrofoil surfaces 327-1, 327-2) between the curved nose fairing portion and the curved tail fairing portion of the gondola housing 330 upper surface.

In some embodiments, the long-track length L of the hydrofoil strut 325 can be the same as or similar to the longitudinal length of a flat or planar portion of the gondola housing 330 upper surface (e.g., the gondola housing 330 upper surface between the curved nose fairing and curved tail fairing portions of the gondola housing 330 upper surface). In some aspects, the long-track length L of the hydrofoil strut 325 can comprise a majority of the total longitudinal length of a flat portion or flat area of the upper surface of the gondola housing 330. In one illustrative example, the long-track length L can be at least 75% of the total longitudinal length of the gondola housing 330 and/or the upper surface of the gondola housing 330. In a further illustrative example, the long-track length L can be at least 60%, advantageously at least 70%, more advantageously at least 80% of the total longitudinal length of the gondola housing 330 and/or the upper surface of the gondola housing 330.

FIG. 4 is a diagram illustrating a perspective view of an example high-speed gondola apparatus 400 that can be coupled to a hull of a survey vessel 490 and used for high-speed MBES surveying, in accordance with some examples. FIG. 5 is a diagram illustrating another perspective view of a high-speed MBES gondola apparatus 500 coupled to the hull of a survey vessel 590, in accordance with some examples.

In some aspects, the high-speed gondola apparatus 400 of FIG. 4 can be the same as or similar to the high-speed gondola apparatus 500 of FIG. 5. The high-speed gondola apparatus 400 and/or the high-speed gondola apparatus 500 can be the same as or similar to one or more of the high-speed gondola apparatus 100 of FIGS. 1A-1D, the high-speed gondola apparatus 200a of FIG. 2A, the high-speed gondola apparatus 200b of FIG. 2B, the high-speed gondola apparatus 300a of FIG. 3A, and/or the high-speed gondola apparatus 300b of FIG. 3B, etc.

The gondola housing 430 of FIG. 4 can be the same as or similar to the gondola housing 530 of FIG. 5, both of which can be the same as or similar to one or more of the gondola housing 130 of FIGS. 1A-1D, the gondola housing 230 of FIGS. 2A-2B, and/or the gondola housing 330 of FIGS. 3A-3B. The hydrofoil strut segment 425 of FIG. 4 can be the same as or similar to the hydrofoil strut segment 525 of FIG. 5, both of which can be the same as or similar to the one or more of the hydrofoil strut segment 125 of FIGS. 1A-1D, the hydrofoil strut segment 225 of FIGS. 2A-2B, and/or the hydrofoil strut segment 325 of FIGS. 3A-3B.

The survey vessel 490 of FIG. 4 can be the same as or similar to the survey vessel 590 of FIG. 5. The survey vessel 490 and the survey vessel 590 can be the same as or similar to the survey vessel 190 of FIG. 1B. In one illustrative example, the survey vessel 490 of FIG. 4 and/or the survey vessel 590 of FIG. 5 can be a semi-displacement or planing hull vessel (e.g., the same as or similar to the semi-displacement or planing hull survey vessel 190 of FIG. 1B).

The gondola housing 530 of FIG. 5 can include a first MBES transducer (e.g., MBES receiver) 542 that can be the same as or similar to the first MBES receiver 142 of FIGS. 1A-1D, a second MBES transducer (e.g., MBES receiver) 544 that can be the same as or similar to the second MBES receiver 144 of FIGS. 1A-1D, and a third MBES transducer (e.g., MBES transmitter) 545 that can be the same as or similar to the MBES transmitter 145 of FIGS. 1A-1D.

In some examples, the fan-shaped acoustic emission associated with an MBES sonar and/or MBES-based bathymetric surveying is achieved using a designed array of transducers (e.g., such as the MBES transducers 142, 144, 145 shown in FIGS. 1B-1D; the MBES transducers 542, 544, 545 shown in FIG. 5; the MBES transducers 742, 744, 745 shown in FIG. 7B; etc.). Transducers within the MBES array may be configured for the generation or transmission of sound waves (e.g., sonar pings) at predetermined or otherwise configured frequencies. For example, these frequencies are typically within the range suitable for underwater propagation and reflection, facilitating precise measurements. Upon activation, the MBES system transmits or propels these sound waves downward (e.g., towards the seafloor) and outward in a fan-like dispersion. This dispersion pattern can be designed or configured to cover a broad swath of the seafloor, thereby enabling the MBES system to map relatively large and/or extensive areas of the seafloor in a singular pass. The angle and orientation of the emitted beams can be calibrated to ensure optimal coverage and resolution. Technological advancements in beamforming have enhanced the control over the distribution and application of soundings. The evolution from traditional equal-angle geometry to equal-distance beam spacing ensures an even distribution of soundings on the seabed. Innovations in beam-forming technology also enable pitch compensation on transmission, providing constant along-track spacing, and roll compensation on receive, ensuring consistent coverage to both port and starboard directions. As these sound waves (e.g., sonar pings) transmitted by the MBES system encounter the seafloor or other objects, they are reflected, back towards the MBES system. The returning echoes are then received by the transducer array of the MBES system. The time elapsed between the emission of the sound wave and the reception of its echo is precisely measured. This time measurement, coupled with the known speed of sound in water, allows for the calculation of the distance to the reflecting surface, thereby facilitating the generation of accurate three-dimensional representations of the seabed.

In some examples, MBES data (e.g., MBES survey and/or bathymetric data) is typically collected from small catamaran or monohull type vessels with a hull length of approximately 8 to 15 meters, and at a surveying speed of approximately 7 knots (e.g., the MBES survey data is collected by the MBES system attached to the survey vessel while the vessel is underway with a forward speed on the water of approximately 7 knots). Vessels of this size are typically suitable for daylight operations only, which thereby limits the total amount of MBES data collection time per day to approximately 8-9 hours/day. Additionally, the small, 8-15 meter catamaran and monohull type vessels are relatively weather sensitive, and can be difficult or impossible to operate safely and/or efficiently in rough seas, rough weather, or sea states higher than 1 meter. Additionally, these types of vessels typically do not have sleeping accommodations onboard for crew, and may be limited in carrying enough fuel to sustain only 1-2 days of operations.

In other examples, MBES data (e.g., MBES survey and/or bathymetric data) may be collected or obtained using relatively large, pure displacement vessel type hulls in the range of 40-60 meters in size (e.g., length). These relatively large displacement vessels may be suitable for MBES surveying and the associated data collection operations for 24 hours per day, but are likewise limited to survey speeds of approximately 7 knots. The displacement hull type vessels with a length of 40-60 meters have a significantly higher operating expense and fuel burn (e.g., 2,000 gallons or more per day), and additionally require a large vessel crew onboard. The relatively large displacement vessels additionally are not typically suitable for use in performing MBES surveys (or various other types of surveys) in relatively shallow waters, based at least in part on safety limitations and/or an increased risk of the relatively large (and relatively deep-keeled) survey vessel grounding out in the shallow water survey area. For example, relatively large displacement vessels may be unsuitable for use in performing shallowest depth or keel clearance MBES surveys, which as noted above, are often associated with shallow water survey depths of approximately 10-40 meters.

The semi-displacement or planing hull survey vessels described and referred to herein (e.g., which can include the survey vessel 190 of FIG. 1B, the survey vessel 490 of FIG. 4, the survey vessel 590 of FIG. 5, etc.) may utilize a “fast trawler” hull type (also referred to as “high-speed trawler”) and may have a size in or near the 15-25 meter length range. In some examples, the fast trawler hull type vessel may be designed to trawl or otherwise operate (e.g., for purposes of conducting MBES surveying using the presently disclosed high-speed MBES gondola, etc.) at forward speeds between 11-19 knots, with 6 days of offshore endurance and onboard accommodations for a 4-5 person crew. In some examples, the survey vessel can utilize a planing hull configuration (e.g., a pure planing hull) having a size in or near the 30-35 meter length range. In one illustrative example, the survey vessel can be a planing hull survey vessel having a length of 33 meters (110 feet) and optimized for planing at speeds of 14 knots.

In some aspects, the presently disclosed high-speed MBES gondola apparatus can be used for high-speed MBES surveying operations conducted at vessel speeds of 13 knots or greater. In some examples, the high-speed MBES gondola apparatus 400 of FIGS. 4 and/or 500 of FIG. 5 can be used for MBES surveying at speeds of 13 knots+4 knots (e.g., 9 knots-17 knots) by the survey vessel 490, 590 (respectively). In some examples, the survey vessel 490, 590 can perform the high-speed MBES survey using the disclosed high-speed MBES gondola, and can cover 400 kilometers or greater or survey line miles per day, effectively quadrupling the number of survey miles covered per day as compared to one smaller vessel using a conventional MBES gondola at conventional MBES survey speeds of 7 knots or less. The semi-displacement or planing hull survey vessels contemplated herein for use with the high-speed MBES gondola apparatus can, in at least some examples, provide greater weather resistance than small, displacement hull-based survey vessels. For example, the semi-displacement or planing hull survey vessels contemplated herein for use with the high-speed MBES gondola apparatus can, in some embodiments, provide 50% greater weather resistance than small displacement hull-based survey vessels.

In some embodiments, the presently disclosed high-speed MBES gondola apparatus can be used for high-speed MBES surveying operations conducted at vessel speeds of 15 knots or greater. In some examples, the high-speed MBES gondola apparatus 400 of FIGS. 4 and/or 500 of FIG. 5 can be used for MBES surveying at speeds of 15 knots+4 knots (e.g., 11 knots-19 knots) by the survey vessel 490, 590 (respectively) or other semi-displacement or planing hull survey vessel(s). In some examples, the survey vessel 490, 590 can perform the high-speed MBES survey using the disclosed high-speed MBES gondola, and can cover 400 kilometers or greater or survey line miles per day, effectively doubling the number of survey miles covered per day as compared to one larger, pure displacement hull vessel using a conventional MBES gondola at conventional MBES survey speeds of 7 knots or less. The semi-displacement or planing hull survey vessel using the disclosed high-speed MBES gondola to survey at 11-19 knot survey speeds can provide double the number of survey line miles per day at 8 times less fuel burn as compared to the larger, pure displacement hull survey vessels, with the same weather resistance as the larger, pure displacement hull survey vessels. In some aspects, the fast trawler and/or semi-displacement or planing hull vessel type contemplated herein for use with the disclosed high-speed MBES gondola apparatus can be capable of traveling 2,500 kilometers before refueling becomes necessary, thereby providing 4-6 days of high-speed MBES surveying operations under normal or expected operating conditions.

Turning to FIGS. 6A-6B, an exemplary embodiment of an over the side, pole-mounted sensor acquisition apparatus 600 is illustrated, which can be used to provide over the side deployment of the high-speed MBES gondola apparatus (e.g., the gondola apparatus 100 of FIGS. 1A-1D, 200 of FIGS. 2A-2B, 300 of FIGS. 3A-3B, 400 of FIG. 4, 500 of FIG. 5, etc.) from the deck or sidewall of a semi-displacement or planing hull survey vessel (e.g., the vessel 610).

In some aspects, the apparatus 600 can also be referred to herein as the “pole-mount 600”. In some examples, the pole-mount 600 can be mobbed to either side (e.g., port, starboard) of a vessel 610, which can be a semi-displacement or planing hull survey vessel as described above. When mounted to a vessel (e.g., such as vessel 610), the pole-mount 600 may also be referred to as a vessel-mounted sensor acquisition apparatus. As illustrated in FIGS. 6A-6B, the vessel 610 can be, for example, 15-25 meter length semi-displacement or planing hull (e.g., fast trawler type, high-speed trawler type, etc.) vessel. In some embodiments, the pole-mount 600 can include an integrated global positioning system (GPS) antenna system to allow for pre dimcon to derive precise offsets before vessel mobbing. The primary pre dimcon can reduce installation costs of the pole-mount 600 over traditional systems because, using the primary pre dimcon, the pole-mount 600 can be installed on the semi-displacement or planing hull vessel 610 as an entire calibrated unit instead of individual, uncalibrated parts. For example, the primary pre dimcon can decrease the mob time by approximately two days, which, in some examples, can reduce the installation costs by approximately $60,000. The pole-mount 600 includes a coupler plate 602 that is mounted to the semi-displacement or planing hull vessel 610. For example, the coupler plate 602 can be removably coupled, directly or indirectly, to a side of the vessel 610. An upper attachment portion 604 is rotatably coupled to the coupler plate 602, such that it can rotate (e.g., pivot) with respect to the coupler plate 602. Rotating the upper attachment portion 604 can transition the pole-mount 600 between a stowed position (as illustrated for example in FIG. 6A) and a deployed position (as illustrated for example in FIG. 6B). The stowed position may also be referred to as a transit position, and the deployed position may also be referred to as a survey position.

In its stowed position (e.g., transit position), the pole-mount 600 is out of the water such that it is positioned for transit. For example, the pole-mount 600 can be substantially horizontal (e.g., relative to the surface of the water and/or relative to a deck of the semi-displacement or planing hull vessel 610) when in the stowed position. In some cases, the pole-mount 600 can be substantially parallel to the surface of the water and/or a deck of the semi-displacement or planing hull vessel 610 when in the stowed position. When the semi-displacement or planing hull vessel 610 is on the water and the pole-mount 600 is in its deployed position (e.g., survey position), a portion of the pole-mount 600 is in the water such that it is positioned to perform a survey. For example, the pole-mount 600 can be substantially vertical in the deployed position. In some aspects, the pole-mount 600 can be substantially perpendicular to the surface of the water and/or a deck of the semi-displacement or planing hull vessel 610 when in the deployed position.

The pole-mount apparatus 600 can include a davit 601, which can be removably coupled to the side of a vessel upon which the pole-mount apparatus is mounted (e.g., semi-displacement or planing hull vessel 610). The davit 601 can include a winch that can be used to transition the pole-mount apparatus 600 from its deployed position to its stowed position. In other words, the winch can be connected to the pole-mount apparatus 600 and the winch can be retracted to rotate the pole-mount apparatus 600 into its stowed position.

A winged pipe segment 606 extends from the upper attachment portion 604. A sensor array portion 608 is removably coupled to the winged pipe segment 606 (e.g., at the distal end of winged pipe segment 606 opposite the upper attachment portion 604). Thus, when the pole-mount apparatus 600 is deployed and performing a survey, at least a portion of the winged pipe segment 606 and the sensor array portion 608 are in the water. In some embodiments, the sensor array portion 608 is fully submerged when the pole-mount apparatus 600 is in the deployed position (e.g., the survey position). The winged pipe segment 606 reduces vortex induced vibrations from the sea and the sensor array portion 608 provides underwater imaging to survey the sea floor. For example, the sensor array portion 608 can include one or more remote sensing arrays for marine surveying.

In one illustrative example, the presently disclosed high-speed MBES gondola can be configured for attachment to the distal end of the pole-mount apparatus 600, for over the side deployment from a deck or sidewall of a semi-displacement or planing hull survey vessel. For example, in some embodiments, the sensor array portion 608 can include, or can be the same as, one or more of the gondola apparatus 100 of FIGS. 1A-1D, 200 of FIGS. 2A-2B, 300 of FIGS. 3A-3B, 400 of FIG. 4, 500 of FIG. 5, etc.

FIG. 7A is a diagram illustrating an example configuration of a high-speed MBES gondola 700 coupled to a pole-mount sensor acquisition apparatus 780 for deployment over the side of a survey vessel, in accordance with some examples. FIG. 7B is a diagram illustrating an additional perspective view of the example configuration of the pole-mounted high-speed MBES gondola 700 of FIG. 7A, in accordance with some examples.

In some aspects, the high-speed MBES gondola 700 of FIGS. 7A-7B can be the same as or similar to one or more of the gondola apparatus 100 of FIGS. 1A-1D, 200 of FIGS. 2A-2B, 300 of FIGS. 3A-3B, 400 of FIG. 4, 500 of FIG. 5, etc. For example, the gondola housing 730 can be the same as or similar to the gondola housing 130 of FIGS. 1A-1D, 230 of FIGS. 2A-2B, 330 of FIGS. 3A-3B, 430 of FIG. 4, 530 of FIG. 5, etc. The coupling/coupler plate 732 of FIG. 7A can be the same as or similar to the coupling/coupler plate 132 of FIGS. 1A-1D, 232 of FIGS. 2A-2B, 332 of FIGS. 3A-3B, etc. The first MBES transducer (receiver) 742 and the second MBES transducer (receiver) 744 of FIG. 7B can be the same as or similar to the first MBES receiver 142 and second MBES receiver 144 (respectively) of FIGS. 1A-1D, the first MBES receiver 542 and second MBES receiver 544 (respectively) of FIG. 5, etc. The MBES transducer (transmitter) 745 of FIG. 7B can be the same as or similar to the MBES transmitter 145 of FIGS. 1A-1D and/or the MBES transmitter 545 of FIG. 5, etc.

A pipe flange coupler 745a can be used to couple the high-speed MBES gondola apparatus 700 to the pole-mount sensor acquisition apparatus 780, as illustrated in FIG. 7A. In some aspects, the pole-mount sensor acquisition apparatus 780 of FIGS. 7A-7B can be the same as or similar to the pole-mount apparatus 600 of FIGS. 6A-6B. For example, the pole-mount sensor acquisition apparatus 780 of FIGS. 7A-7B can include a winged pipe segment 706 that is the same as or similar to the winged pipe segment 606 of FIGS. 6A-6B.

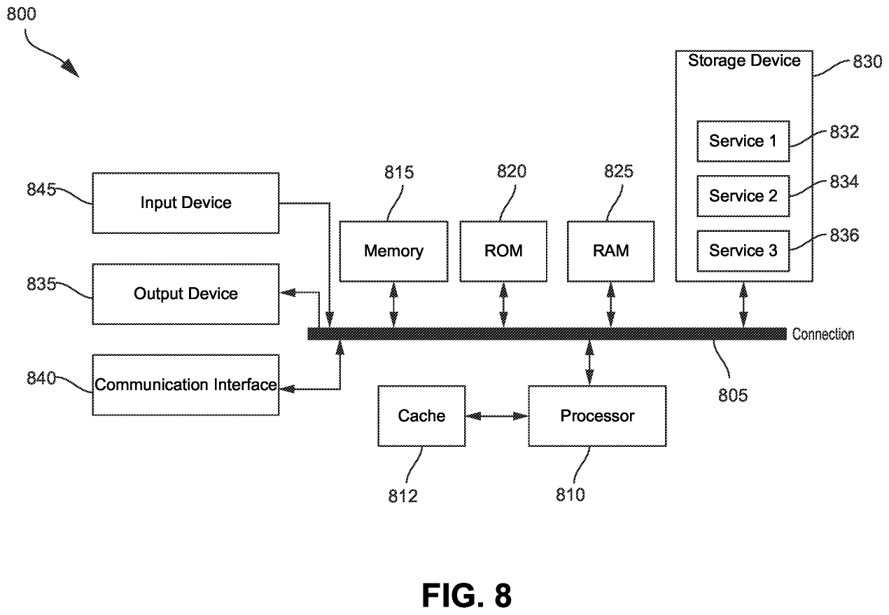

FIG. 8 is a diagram illustrating an example of a system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some aspects, computing system 800 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 may include a cache 812 of high-speed memory connected directly with, in close proximity to, or integrated as part of processor 810.

Processor 810 may include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some aspects, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. Aprocessor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“<”) and greater than or equal to (“>”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

1. A gondola for high-speed multibeam echosounder (MBES) surveying by a semi-displacement or planing hull survey vessel, the gondola comprising:
a housing having an enclosed volume extending between an upper surface of the housing and a lower surface of the housing, wherein a multi-head MBES transducer array is provided within the enclosed volume and extends through one or more apertures of the lower surface;
a nose fairing extending from a forward portion of the housing at a maximal width of the upper surface and the lower surface;
a tail fairing extending from an aft portion of the housing at a minimal width of the upper surface and the lower surface; and
a hydrofoil strut segment having first and second hydrofoil surfaces extending between a first distal end of the hydrofoil strut segment and a second distal end of the hydrofoil strut segment, wherein:
the first distal end of the hydrofoil strut segment includes a coupling configured for flush attachment to the upper surface of the housing;
the second distal end of the hydrofoil strut segment includes a coupler portion configured for attachment to the semi-displacement or planing hull survey vessel; and
the first and second hydrofoil surfaces are orthogonal to the upper surface of the housing and are configured to generate opposing hydrodynamic forces during high-speed MBES surveying by the semi-displacement or planing hull survey vessel.

2. The gondola of claim 1, wherein a long-track length of the hydrofoil strut segment is the same as a length of a planar portion of the upper surface of the housing between the nose fairing and the tail fairing.

3. The gondola of claim 1, wherein a long-track length of the hydrofoil strut segment is equal to at least 75% of a longitudinal length of the upper surface of the housing.

4. The gondola of claim 1, wherein the gondola is configured for high-speed MBES surveying operations at speeds greater than 10 knots.

5. The gondola of claim 1, wherein the gondola is configured for high-speed MBES surveying operations at speeds greater than 15 knots.

6. The gondola of claim 1, wherein the gondola has a hydrodynamic profile configured to provide reduced hydrodynamic resistance at survey speeds greater than 10 knots, based at least in part on the hydrofoil strut segment comprising a rounded leading surface and a tapered trailing edge.

7. The gondola of claim 1, wherein the hydrofoil strut segment further includes a pipe segment orthogonal to the upper surface of the housing and disposed between the first and second hydrofoil surfaces.

8. The gondola of claim 1, wherein the first and second hydrofoil surfaces are coupled to one another along a leading edge of the hydrofoil strut segment adjacent to the nose fairing of the housing.

9. The gondola of claim 8, wherein the first and second hydrofoil surfaces are coupled to one another along a trailing edge of the hydrofoil strut segment adjacent to the tail fairing of the housing, and wherein a first width of the hydrofoil strut segment at the leading edge is greater than a second width of the hydrofoil strut segment at the trailing edge.

10. The gondola of claim 9, wherein the hydrofoil strut segment has a third width between the leading edge and the trailing edge, and wherein the third width is greater than the first width and the second width.

11. The gondola of claim 1, wherein the coupling is coplanar with the upper surface of the housing in the flush attachment of the hydrofoil strut segment first distal end to the gondola housing.

12. The gondola of claim 1, wherein the multi-head MBES transducer array includes a transmitter aligned along the longitudinal axis of the housing, and first and second receivers disposed on opposite sides of the transmitter.

13. The gondola of claim 12, wherein the transmitter extends through a first aperture of the one or more apertures and is substantially flush with the lower surface of the housing.

14. The gondola of claim 13, wherein the first and second receivers extend through respective apertures of the one or more apertures and are each substantially flush with the lower surface of the housing.

15. The gondola of claim 1, wherein the nose fairing and the tail fairing are flush with upper surface of the housing and the lower surface of the housing.

16. The gondola of claim 1, wherein the upper surface of the housing comprises a triangular shape tapering from the maximal width at an attachment point with the nose fairing to the minimal width at an attachment point with the tail fairing.

17. The gondola of claim 1, wherein the tail fairing tapers to a point, and wherein the taper of the tail fairing is continuous along the longitudinal axis with the taper of the housing.

18. The gondola of claim 1, wherein the upper surface of the housing comprises a planar surface, and wherein the lower surface of the housing comprises a curved surface.

19. The gondola of claim 1, wherein a longitudinal axis of the housing extends between the nose fairing coupled to the forward portion and the tail fairing coupled to the aft portion, and wherein the upper surface and the lower surface are tapered along the longitudinal axis of the housing from the maximal width to the minimal width.

20. A high-speed multibeam echosounder (MBES) surveying system, the system comprising:
a high-speed survey vessel having a semi-displacement hull or a planing hull; and
a high-speed MBES gondola coupled to the semi-displacement hull or the planing hull of the high-speed survey vessel, wherein the high-speed MBES gondola comprises:
a housing having an enclosed volume extending between an upper surface of the housing and a lower surface of the housing, wherein a multi-head MBES transducer array is provided within the enclosed volume and extends through one or more apertures of the lower surface;
a nose fairing extending from a forward portion of the housing at a maximal width of the upper surface and the lower surface;
a tail fairing extending from an aft portion of the housing at a minimal width of the upper surface and the lower surface; and
a hydrofoil strut segment having first and second hydrofoil surfaces extending between a first distal end of the hydrofoil strut segment and a second distal end of the hydrofoil strut segment, wherein:
the first distal end of the hydrofoil strut segment includes a coupling configured for flush attachment to the upper surface of the housing;
the second distal end of the hydrofoil strut segment includes a coupler portion configured for attachment to the semi-displacement hull or the planing hull of the high-speed survey vessel; and
the first and second hydrofoil surfaces are orthogonal to the upper surface of the housing and are configured to generate opposing hydrodynamic forces during high-speed MBES surveying by the semi-displacement hull or planing hull high-speed survey vessel.
